(19) United States
(12) Patent Application Publication
(10) Pub. No.: US 2003/0055997 A1
(43) Pub. Date: Mar. 20, 2003

(54) Communication system and communication control method

(76) Inventor: Toshiyuki Tanaka, Minneapolis, MN (US)

Correspondence Address: HARNESS, DICKEY & PIERCE, P.L.C., P.O. BOX 828, BLOOMFIELD HILLS, MI, 48303, US

(21) Appl. No.: 10/189,808

(22) Filed: Jul. 3, 2002

(30) Foreign Application Priority Data
Jul. 6, 2001 (JP) 2001-206669

(51) Int. Cl. G06F 15/16

(52) U.S. Cl. 709/232

(57) ABSTRACT

The control program loads an FCP stored in the ROM 5 onto the register 4 within the control section 3. Next, by referring to the FCP in the register 4, AV/C command data is generated, and it is transferred to the target 1. When an AV/C command is transferred again, by referring to the FCP that has already been loaded on the register 4, AV/C command data is generated, and it is transferred to the target 1.

### BACKGROUND OF THE INVENTION

1. Technical Field of the Invention

The present invention relates to an AV/C compatible communication system using an IEEE1394 chip and a communication control method. More particularly, the present invention relates to a communication system and a communication control method, which reduce the load on the firmware and improve the system performance.

2 Conventional Technology

At present, a digital interface called an IEEE (Institute of Electrical and Electronics Engineers) 1394 is attracting attention in various fields. The IEEE1394 is a high-speed serial interface with transfer speeds of 100 [Mbps], 200 [Mbps] and 400 [Mbps].

When data for moving pictures and music pieces are transferred in real time by the IEEE1394, an IEC61883 protocol is used to arbitrate the transmission bus, and the data is transferred using an isochronous communication. The IEC61883 protocol corresponds to an upper layer of the IEEE1394, and prescribes transfer of consumer digital audio/video real-time AV data, arbitration of AV signal connections among equipment, and control command transfer protocols.

In the mean time, as a protocol for transferring static data such as data for still pictures and texts, a protocol called an asynchronous connection has been set up. This protocol arbitrates the transfer bus by AV/C commands, and transfers data by using an asynchronous communication. AV/C commands are a set of commands that have been developed for remotely controlling consumer AV devices that are connected by a network such as an IEEE1394 network. AV/C commands are aimed at realizing the required functions with minimum device requirement so that they can be mounted on simple AV devices. Accordingly, the FCP (Functional Control Protocol), a framework of protocols for controlling AV equipment on IEEEE1394, is used as is for AV/C command data, and its data structure has a few overheads.

In an asynchronous communication, the side that transfers commands placed in a packet is called a controller, and the side that receives the commands is called a target. The target returns a control signal indicating an execution result in response to a command depending on the requirements, in other words, a response in a packet to the controller. Commands and responses are communicated between one controller and one target. A series of exchanges that starts upon transferring a command and ends upon receiving a response is called a command transaction.

When packets using the FCP such as AV/C command packets are transferred from a controller to a target, all quadlets are generated and written in a packet memory. This wastes the CPU power and cycles, and impedes faster operation of control programs.

Also, to perform the command transaction described above, for example, it is specified that a response be returned within 100 [msec]. For this reason, the firmware needs to estimate a time required for the processing, which wastes time, and lowers the system performance.

The present invention is made in view of the problems described above, and its object is to provide a communication system and a communication control method that lower the load on the firmware and improve the system performance.

### SUMMARY OF THE INVENTION

To solve the problems described above, a communication system in accordance with the present invention pertains to a communication system for controlling communication with another electronic device, the communication system comprising: a counter that calculates a specified time; a processing device that processes a control signal; and a control device that transfers the control signal to the other electronic device, wherein the control device receives a signal from the counter and the control signal from the processing device, transfers the control signal to the other electronic device when the control signal is returned from the processing device within the specified time calculated by the counter, and generates and transfers a signal indicating that a process is being performed to the other electronic device when the control signal is not returned from the processing device within the specified time calculated by the counter.

Here, the control device may include a register that temporarily retains data and a memory device that stores a communication protocol, wherein the control device may write the communication protocol in the register, refer to the communication protocol in the resister, and generate for the other electronic device a signal indicating that a process is being performed.

In accordance with the communication system described above, the FCP in a RAM (memory device) is loaded onto a register, and AV/C command data (control signal) is generated. For this reason, AV/C command data can be automatically generated and automatically transferred by a minimum amount of accesses from the control section (the control device or CPU). This prevents wastes of the CPU power and cycles, and promotes faster operation of the control program.

Also, to solve the problems described above, a communication system in accordance with a first embodiment of the present invention pertains to a communication control method for controlling communication with another electronic device, the method comprising: in response to receiving a signal from the other electronic device, processing the signal and starting counting; waiting for a counter signal that is generated when a specified count value is reached to be received or a control signal indicating a completion of the processing; transferring the control signal to the other electronic device when the control signal is received before the counter signal is received; and transferring a signal indicating that a process is being performed to the other electronic device when the counter signal is received before the control signal is received.

By the communication control method described above, for example, when a counter that counts 100 [msec] is provided, an INTERIM response (a control signal indicating that a processing is being performed) can be returned when 100 [msec] has elapsed since a command (control signal) is received from a target (a second electronic device). Therefore, the INTERIM response can be returned without giving a load on the firmware (processing device), and the system performance can be improved.

Also, to solve the problems described above, a communication system in accordance with a second embodiment of the present invention pertains to a communication control method for controlling communication with another electronic device, the communication control method comprising: in response to receiving a signal from the other electronic device, processing the signal; and immediately transmitting a signal indicating that a process is being performed to the other electronic device.

By the communication control method described above, an INTERIM response (a control signal indicating that a processing is being performed) can be returned at the time when a command (control signal) is received from a target (a second electronic device). As a result, the processing can be performed without being substantially restrained by the return transmission time at the firmware (processing device), and therefore the system performance can be improved.

### BRIEF DESCRIPTION OF THE DRAWINGS

FIG. 1 is a block diagram showing a structure of a communication system in accordance with the present invention.

FIG. 2 shows AV/C command data that is transferred to the target 1.

FIGS. 3(A) and (B) show a communication control method in accordance with the present invention.

FIG. 4 is a block diagram showing a structure of a communication system that realizes a communication control method in accordance with the present invention.

FIG. 5 shows a flow of frames in the communication system in accordance with the present invention.

FIGS. 6(A) and (B) show AV/C flows of the command transaction

FIG. 7 is a block diagram showing a structure of a communication system that realizes a communication control method in accordance with the present invention.

FIG. 8 shows a flow of frames in the communication system in accordance with the present invention.

FIG. 9 shows an AV/C flow of the command transaction.

### DETAILED DESCRIPTION OF THE PREFERRED EMBODIMENTS OF THE PRESENT INVENTION

Descriptions will be made with reference to the accompanying drawings.

First, a communication control method in accordance with a first embodiment of the present invention will be described.

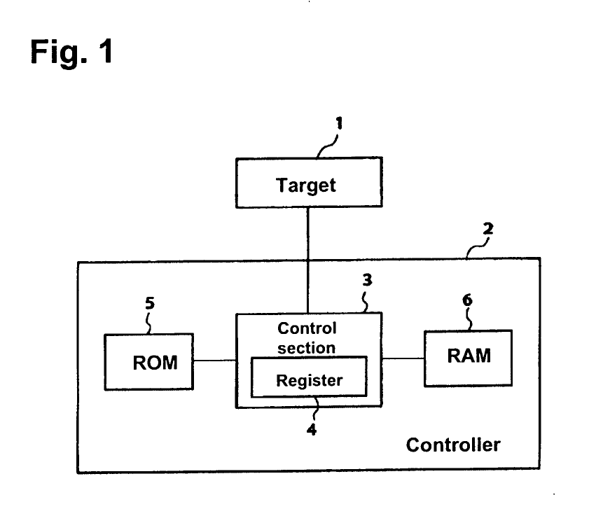

FIG. 1 is a block diagram showing a structure of a communication system that realizes the communication control method in accordance with the first embodiment of the present invention.

FIG. 1 shows a target to be controlled (AV equipment) 1, and a controller 2 that transfers a command in a packet to the target 1. The controller 2 is provided with a control section 3 that controls the controller device, a register 4 that is a high-speed memory for operations provided within the control section 3, a ROM 5 that stores communication programs and the FCP (Function Control Protocol that is a protocol for controlling AV equipment on IEEE1394), and a RAM 6 that temporarily stores AV/C command data (packet memory).

The control section 3 loads data from the ROM 5 onto the register 4, and performs various types of operations on the register 4 to process the data. AV/C command data processed by the control section 3 is temporarily stored in the RAM 6, and then transferred to the target 1.

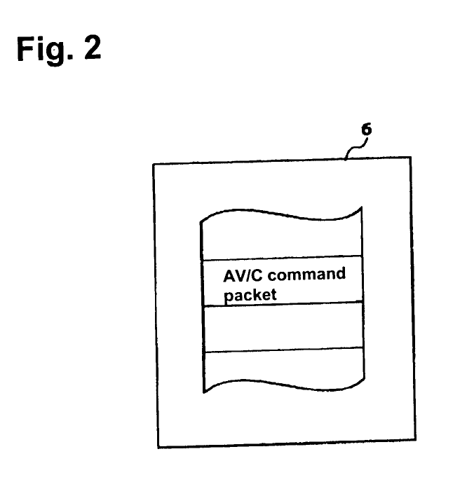

FIG. 2 shows AV/C command data that is transferred to the target 1.

The AV/C command data shown in FIG. 2 is provided with an AV/C command packet. The framework of the FCP is used as is for the AV/C command data, and its data structure has a few overheads.

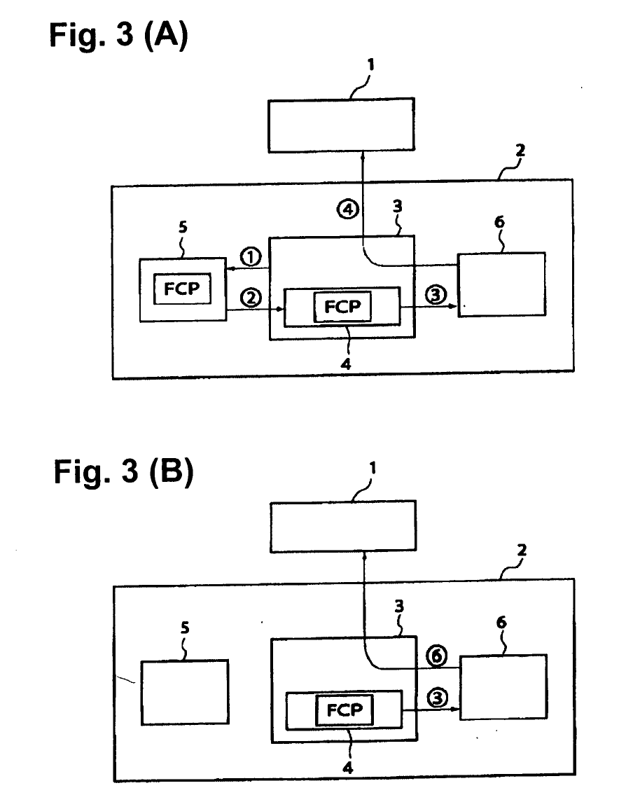

FIGS. 3(A) and (B) show a communication control method in accordance with the first embodiment of the present invention. FIG. 3(A) shows a control method for communication for the first time, and FIG. 3(B) shows a control method for communication for the second time and later.

FIGS. 3(A) and (B) show the target to be controlled 1, the controller 2 that transfers a command in a packet to the target 1, the control section 3 that controls the controller device, the register 4, which is a high-speed memory for operations provided within the control section 3, the ROM 5 that stores communication programs, FCP and the like, and the RAM that temporarily stores AV/C command data (packet memory) 6, which are shown in FIG. 1.

In transferring an AV/C command to the target 1, first, an instruction to generate the command is sent from the control section 3 to the ROM 5 (ε in the figure). The control program loads the FCP stored in the ROM 5 onto the register 4 within the control section 3 (∉ in the figure). Next, referring to the FCP in the register 4, AV/C command data (see FIG. 2) is generated, which is then stored in the RAM 6 (∠ in the figure). When the AV/C command data is ready to be transferred, the control section 3 transfers the AV/C command data to the target 1 (∇ in the figure).

In the present embodiment, when an AV/C command is transferred to the target 1 again, the FCP that has already been loaded on the register 4 is referred to, and AV/C command data is generated (see FIG. 2), and stored in the RAM 6 (∠ in the FIGS. 3(A)(B)). At this moment, a frame for an AV/C command packet is prepared in advance in the AV/C command data to be stored in the packet memory. When the AV/C command data is ready to be transferred, the control section 3 transfers the AV/C command data to the target 1 (® in the figure).

As described above, in accordance with the communication control method of the present embodiment, the FCP in the RAM is loaded onto the register, and AV/C command data is created. For this reason, AV/C command data can be automatically generated and automatically transferred by a minimum amount of accesses from the control section (the control device or CPU). This prevents wastes of the CPU power and cycles, and promotes faster operation of the control program.

Next, a communication control method and a communication system in accordance with a second embodiment of the present invention will be described.

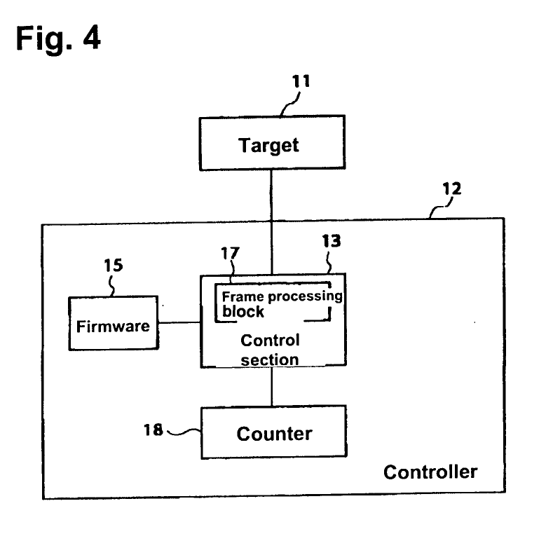

FIG. 4 is a block diagram showing a structure of a communication system that realizes the communication control method in accordance with the second embodiment of the present invention.

FIG. 4 shows a target to be controlled (AV equipment) 11, and a controller 12 that transfers a command in a packet to the target 11. The controller 12 is provided with a control section 13 that controls the controller device, a frame processing section 17 that processes AV/C command frames prepared within the control section 13, a firmware 15 that executes communication programs, and a counter 18 that counts 100 [msec]. In this embodiment, the number counted by the counter 18 is set to be 100 [msec] as an example. However, without being limited to this value, a variety of other values can be used.

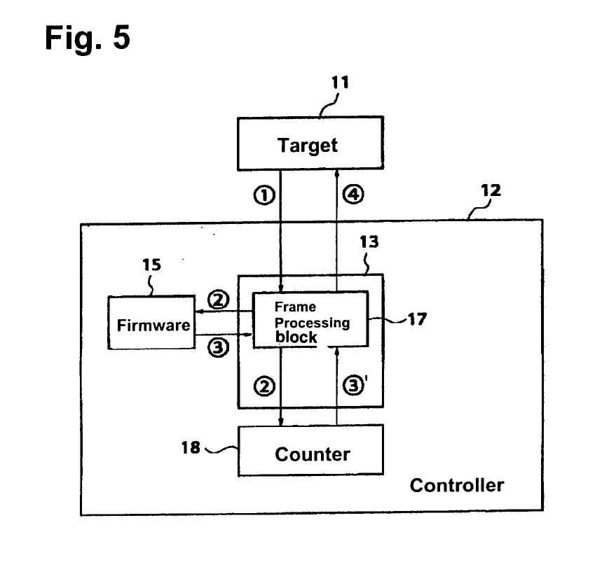

FIG. 5 shows a flow of frames in the communication system in accordance with the second embodiment of the present invention.

FIG. 5 shows the target to be controlled (AV equipment) 11, the controller 12 that transfers a command in a packet to the target 11, the control section 13 that controls the controller device, the frame processing section 17 that processes AV/C command frames, the firmware 15 that executes communication programs, and the counter 18 that counts 100 [msec], which are shown in FIG. 4.

Referring to FIG. 5, first, the target 11 transfers an AV/C command (ε in the figure). When the command is transferred from the target 11, the frame processing section 17 simultaneously transfers the AV/C command to the firmware 15 and the counter 18 (∉ in the figure).

The firmware 15 processes the received AV/C command, and returns, for example, an ACCEPTED response (notifying that the command has been executed) to the frame processing section 17 (∠ in the figure). In the mean time, the counter 18 starts counting upon receiving the AV/C command, and returns an INTERIM response (notifying that the command is being processed) after 100 [msec] has elapsed to the frame processing section 17 (∠′ in the figure).

The frame processing section 17 transfers the aforementioned ACCEPTED response or the INTERIM response to the target 1 (∇ in the figure). Here, it is specified that the response be returned within 100 [msec], for example. Therefore, the frame processing section 17 selects the aforementioned ACCEPTED response or the INTERIM response, and transfer the selected one to the target 11.

Here, AV/C flows of the aforementioned command transaction will be described with reference to the drawings.

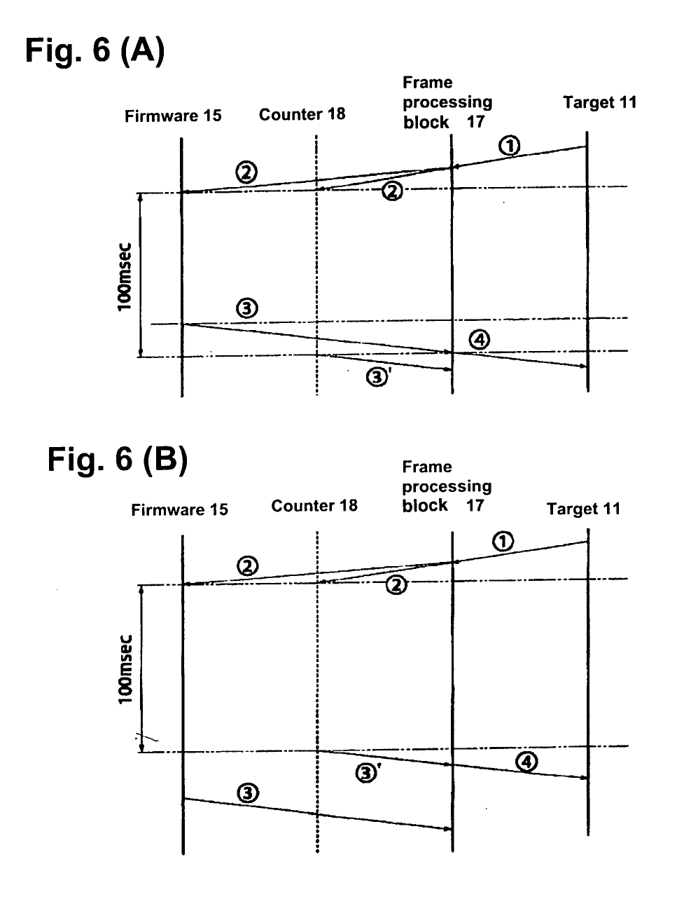

FIGS. 6(A) and (B) show AV/C flows of the command transaction. FIG. 6(A) shows a case when the ACCEPTED response is returned within 100 [msec], and FIG. 6(B) shows a case when the ACCEPTED response is not returned within 100 [msec].

FIGS. 6(A) and (B) schematically show the target 11, the frame processing section 17, the counter 18 and the firmware 18, which are shown in FIG. 5.

As shown in FIG. 6(A), first, the target 11 transfers an AV/C command (ε in the figure). When the command is transferred from the target 11, the frame processing section 17 simultaneously transfers the AV/C command to the firmware 15 and the counter 18 (∉ in the figure).

The firmware 15 processes the received AV/C command, and returns, for example, an ACCEPTED response (notifying that the command has been executed) to the frame processing section 17 (∠ in the figure). Here, the ACCEPTED response is returned within 100 [msec].

In the mean time, the counter 18 starts counting upon receiving the AV/C command, and returns an INTERIM response (notifying that the command is being processed) after 100 [msec] has elapsed to the frame processing section 17 (∠′ in the figure).

Since the frame processing section 17 receives the ACCEPTED response before it receives the INTERIM response, it transfers the ACCEPTED response received earlier to the target 11 (∇ in the figure).

As shown in FIG. 6(B), like in FIG. 6(A), the target 11 transfers an AV/C command (ε in the figure). When the command is transferred from the target 11, the frame processing section 17 simultaneously transfers the AV/C command to the firmware 15 and the counter 18 (∉ in the figure).

The firmware 15 processes the received AV/C command, and returns, for example, an ACCEPTED response (notifying that the command has been executed) to the frame processing section 17 (∠ in the figure). Here, the ACCEPTED response is returned after 100 [msec] has elapsed.

In the mean time, the counter 18 starts counting upon receiving the AV/C command, and returns an INTERIM response (notifying that the command is being processed) after 100 [msec] has elapsed to the frame processing section 17 (∠′ in the figure).

Since the frame processing section 17 receives the INTERIM response before it receives the ACCEPTED response, it transfers the INTERIM response received earlier to the target 11 (∇ in the figure).

Conventionally, when an ACCEPTED response or the like is not returned within 100 [msec], the firmware needs to prepare an INTERIM response. This lowers the system performance. However, as described above, in the communication control method in accordance with the present embodiment, the counter that counts 100 [msec] is provided, and an INTERIM response can be returned when 100 [msec] has elapsed. Therefore, an INTERIM response can be returned without giving the load on the firmware, and the system performance can be improved.

Next, a communication control method in accordance with a third embodiment of the present invention will be described.

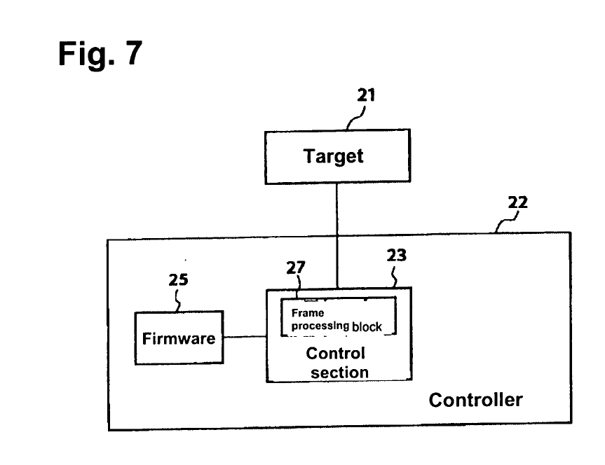

FIG. 7 is a block diagram showing a structure of a communication system that realizes the communication control method in accordance with the third embodiment of the present invention.

FIG. 7 shows a target to be controlled (AV equipment) 21, and a controller 22 that transfers a command in a packet to the target 21. The controller 22 is provided with a control section 23 that controls the controller device, a frame processing section 27 that processes AV/C command frames prepared within the control section 23, and a firmware 25 that executes a communication program.

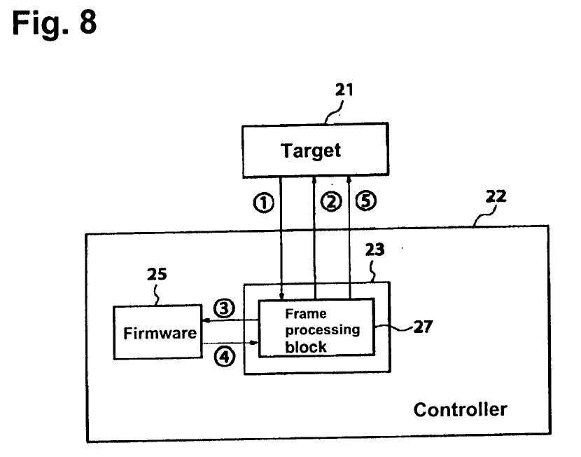

FIG. 8 shows a flow of frames in the communication system in accordance with the third embodiment of the present invention.

FIG. 8 shows the target to be controlled (AV equipment) 21, the controller 22 that transfers a command in a packet to the target 21, the control section 23 that controls the controller device, the frame processing section 27 that processes AV/C command frames, and the firmware 25 that executes a communication program, which are shown in FIG. 7.

Referring to FIG. 8, first, the target 21 transfers an AV/C command to the frame processing section 27 (ε in the figure).

When the command is transferred from the target 21 to the frame processing section 27, an INTERIM response (notifying that the command is being processed) is immediately returned from the frame processing section 27 to the target 21 (∉ in the figure). Also, substantially at the same time, the AV/C command is transferred from the frame processing section 27 to the firmware 25 (∠ in the figure).

The firmware 25 processes the received AV/C command, and returns, for example, an ACCEPTED response (notifying that the command has been executed) to the frame processing section 27 (∇ in the figure).

When the frame processing section 27 receives the aforementioned ACCEPTED response, it transfers the same to the target 21 (® in the figure).

An AV/C flow of the above command transaction will be described with reference to the drawings.

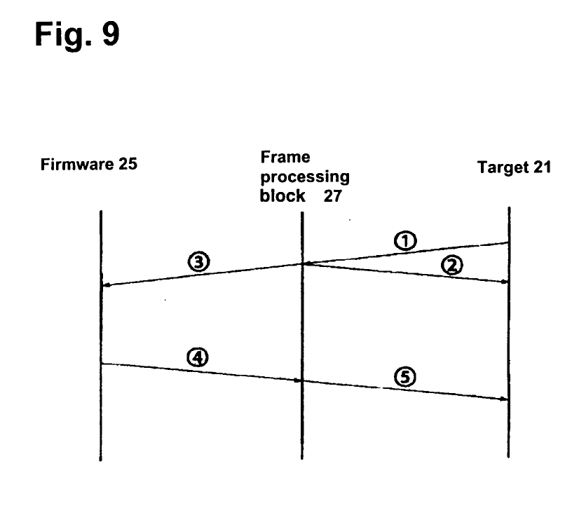

FIG. 9 shows an AV/C flow of the command transaction.

FIG. 9 schematically shows the target 21, the frame processing section 27 and the firmware 25, which are shown in FIG. 7 and FIG. 8.

As shown in FIG. 9, first, the target 21 transfers an AV/C command to the frame processing section 27 (ε in the figure).

When the command is transferred from the target 21 to the frame processing section 27, an INTERIM response (notifying that the command is being processed) is immediately returned from the frame processing section 27 to the target 21 (∉ in the figure). Also, substantially at the same time, the AV/C command is transferred from the frame processing section 27 to the firmware 25 (∠ in the figure).

The firmware 25 processes the received AV/C command, and returns, for example, an ACCEPTED response (notifying that the command has been executed) to the frame processing section 27 (∇ in the figure).

When the frame processing section 27 receives the aforementioned ACCEPTED response, it transfers the same to the target 21 (® in the figure).

Conventionally, when an ACCEPTED response or the like is not returned within 100 [msec], the firmware needs to prepare an INTERIM response. This lowers the system performance. However, as described above, in the communication control method in accordance with the present embodiment, since an INTERIM response is returned at the time when a command from the target is received, and the process can be performed without being substantially restrained by the return transmission time at the firmware, the system performance can be improved.

It is clear from the above description that, by the communication control method and the like in accordance with the embodiments of the present invention, an FCP in a RAM is loaded onto a register, and an AV/C command data is created. For this reason, AV/C command data can be automatically generated and automatically transferred by a minimum amount of accesses from a control section (CPU). This prevents wastes of the CPU power and cycles, and promotes a faster operation of the control program.

Also, by the communication control method and the like in accordance with the embodiments of the present invention, a counter that counts 100 [msec] is provided, and an INTERIM response can be returned when 100 [msec] has elapsed. Therefore, the INTERIM response can be returned without giving a load on the firmware, and the system performance can be improved.

Furthermore, by the communication control method and the like in accordance with the embodiments of the present invention, an INTERIM response is returned at the time when a command from a target is received, and the processing can be performed without being substantially restrained by the return transmission time at the firmware. As a result, the system performance can be improved.

The entire disclosure of Japanese Application No. 2001-206669, filed Jul. 6, 2001 are incorporated by reference.

What is claimed is:

1. A communication system for controlling communication with another electronic device, the communication system comprising:
a counter that calculates a specified time;
a processing device that processes a control signal; and
a control device that transfers the control signal to the other electronic device,
wherein the control device receives a signal from the counter and the control signal from the processing device, transfers the control signal to the other electronic device when the control signal is returned from the processing device within the specified time calculated by the counter, and generates and transfers a signal indicating that a process is being performed to the other electronic device when the control signal is not returned from the processing device within the specified time calculated by the counter.

2. A communication system according to claim 1, wherein the control device comprises a register that temporarily retains data and a memory device that stores a communication protocol, writes the communication protocol in the register, refers to the communication protocol in the resister, and generates for the other electronic device a signal indicating that a process is being performed.

3. A communication control method for controlling communication with another electronic device, the method comprising:
in response to receiving a signal from the other electronic device, processing the signal and starting counting;
waiting for a counter signal that is generated when a specified count value is reached to be received or a control signal indicating a completion of the processing;
transferring the control signal to the other electronic device when the control signal is received before the counter signal is received; and
transferring a signal indicating that a process is being performed to the other electronic device when the counter signal is received before the control signal is received.

4. A communication control method for controlling communication with another electronic device, the communication control method comprising:
in response to receiving a signal from the other electronic device, processing the signal; and
immediately transmitting a signal indicating that a process is being performed to the other electronic device.
